(19) United States
(12) Patent Application Publication
(10) Pub. No.: US 2017/0126508 A1
(43) Pub. Date: May 4, 2017

(54) METHOD AND SYSTEM FOR IDENTIFYING A NETWORK-CONNECTED SENSOR DEVICE BASED ON ELECTRICAL FINGERPRINT

(71) Applicant: Ayyeka Technologies Ltd., Jerusalem (IL)

(72) Inventors: Yair POLEG, Nes-Harim (IL); Ariel STERN, Lachish (IL); Roni FORTE, Rehovot (IL); Idan SASSON, Yahud (IL)

(21) Appl. No.: 15/220,442

(22) Filed: Jul. 27, 2016

(30) Foreign Application Priority Data
Oct. 28, 2015 (GB) 1519080.4

(51) Int. Cl. H04L 12/24; G06N 7/00; G06N 99/00

(52) U.S. Cl. CPC H04L 41/16; G06N 99/005; G06N 7/005

(57) ABSTRACT

A method and a system for identifying a network-connected sensor device based on electrical fingerprint. The method may include the following steps: applying, at specified time slots, a set of electrical measurements to a sensor being connected to a network of sensors, to yield a set of electrical parameters; deriving data measured by the sensor at said time slots; representing, for at least some of the time slots, the set of electrical parameters and the corresponding data measured by the sensor, as a vector in a single samples space; and applying machine learning techniques to the vectors in the samples space, to derive a sensor-specific fingerprint of the sensor.

### CROSS-REFERENCE TO RELATED APPLICATIONS

This application claims priority of Great Britain Patent Application No. GB1519080.4, filed Oct. 28, 2015, which is hereby incorporated by reference.

### FIELD OF THE INVENTION

The present invention relates generally to the field of sensor networks, and in particular, such networks that include sensors that transmit measurements via a wireless channel.

### BACKGROUND OF THE INVENTION

Many infrastructure systems, such as water pipes and drainage systems, require measurements of their operation on an ongoing basis. Sensors, of many kinds and types, are being deployed on site in order to measure various metrics and transmit the measurements, usually via a communication network, to a centralized control center, where the data is being analyzed.

On the very basic hardware level of the sensors, two types of sensors are being used in sensory networks: analog sensors which may consist on current loops that may measure variation in various physical parameters, and digital sensors which comply with sending the collected data over a specified protocol such as TCP-IP, RS232/RS485.

Such sensor networks are prone to malicious attacks of various kinds. One specific difficult-to-handle scenario is a malicious replacement of one or more of the sensors. Consequently, sensitive information may leak out of the network (in a case the malicious replacement involves monitoring of the data). Additionally, the data collected from the sensor cannot be trusted anymore.

Therefore, it would be advantageous to provide a method to validate the authenticity of the sensors in a sensory network at any given point of time, wherein the authentication is on the hardware level rather than on the logic-network level which can be more easily intercepted.

### SUMMARY OF THE INVENTION

According to some embodiments of the present invention, a method and a system for identifying a network-connected senor device based on electrical fingerprint are provided herein. The method may include the following steps: applying, at specified time slots, a set of electrical measurements to a sensor being connected to a network of sensors, to yield a set of electrical parameters; deriving data measured by the sensor at said time slots; representing, for at least some of the time slots, the set of electrical parameters and the corresponding data measured by the sensor, as a vector in a single samples space; and applying machine learning techniques to the vectors in the samples space to derive a sensor-specific fingerprint of the sensor. The system may implement the aforementioned method in a form of an on-site controller for sensors that is connected over a communication network.

These additional, and/or other aspects and/or advantages of the present invention are set forth in the detailed description which follows.

### BRIEF DESCRIPTION OF THE DRAWINGS

For a better understanding of the invention and in order to show how it may be implemented, references are made, purely by way of example, to the accompanying drawings in which like numerals designate corresponding elements or sections. In the accompanying drawings:

FIG. 1 is a schematic block diagram illustrating the environment of the system in accordance with some embodiments of the present invention;

FIG. 2 is a schematic block diagram illustrating the system in accordance with some embodiments of the present invention; and

FIG. 3 is a high level flowchart illustrating the method in accordance with some embodiments of the present invention;

The drawings together with the following detailed description make the embodiments of the invention apparent to those skilled in the art.

### DETAILED DESCRIPTION OF THE INVENTION

With specific reference now to the drawings in detail, it is stressed that the particulars shown are for the purpose of example and solely for discussing the preferred embodiments of the present invention, and are presented in the cause of providing what is believed to be the most useful and readily understood description of the principles and conceptual aspects of the invention. In this regard, no attempt is made to show structural details of the invention in more detail than is necessary for a fundamental understanding of the invention. The description taken with the drawings makes apparent to those skilled in the art how the several forms of the invention may be embodied in practice.

Before the embodiments of the invention are explained in detail, it is to be understood that the invention is not limited in its application to the details of construction and the arrangement of the components set forth in the following descriptions or illustrated in the drawings. The invention is applicable to other embodiments and may be practiced or carried out in various ways. Also, it is to be understood that the phraseology and terminology employed herein are for the purpose of description and should not be regarded as limiting.

Some embodiments of the present invention are based on the observation that no two electrical components are identical. As typical industrial controllers supports various sensor interfaces, some of which are current loops (which require 2-4 wires), others are voltage inputs, and some are serial interfaces (e.g., RS232/RS485/SDI12). Therefore, each sensor is connected by approximately five wires to the controller.

It is suggested herein to fingerprint a sensor by learning to identify a set of electrical properties. These properties can be measured between pairs/triplets/any-other-number of the wires connecting it to the controller, using an onboard measurement system.

According to some embodiments of the present invention, it is suggested to use a plurality of electrical properties as measured metrics by which a sensor can be identified. These metrics may include: complex impedance (covering resistance, capacitance and inductance) that may be checked over pairs of wires of all wires connecting a sensor to the controller; an impulse response, or any other response of the sensor to a predefined signal of a known waveform can be checked and analyzed (usually by applying it to one pair of wires and measuring the response on a different pair); and cross-talk between various pairs of wires.

It is important to collect enough such samples to identify a specific sensor with high probability. Additionally, as the aforementioned electrical properties may be affected by other factors, these electrical properties should be analyzed within the context of the operation of the sensors. Therefore, the controller will also collect the parameters measured by the sensor, as well as environmental parameters such as humidity and temperature. These parameters will help to cancel out or normalize the effect of such environmental conditions.

The method in accordance of some embodiments of the present invention may include the following steps: applying a set of electrical measurements to a sensor upon each activation of the sensor to yield a set of electrical parameters; deriving data measured by the sensor with its corresponding electrical parameters and ambient parameters, to yield a vector denoting a data point; repeating the deriving over a predefined period of time; arranging all collected data points on a single samples space; and applying machine learning techniques onto the samples space to derive a sensor-specific fingerprint

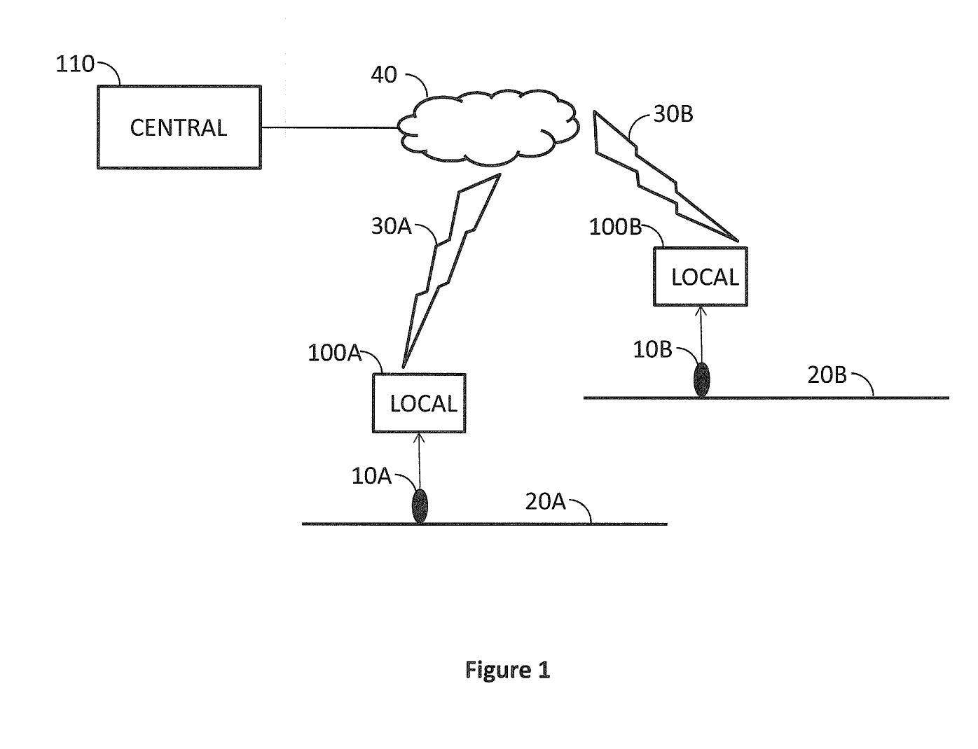

FIG. 1 is a schematic block diagram of a system illustrating some embodiments of the present invention. A plurality of local devices 100A and 100B, each having its respective sensor 10A and 10B coupled to a respective infrastructure 20A and 20B, are shown. Plurality of local devices 100A and 100B are connected over respective wireless or wireline channels 30A and 30B to a network 40 and possibly to a central processing unit 110.

In operation, each of plurality of local devices 100A and 100B derives a set of electric measurements from its respective at least one sensor 10A and 10B. These measurements may be derived when the sensor is “cold” and again once activated and settled or at any specified time slots. These measurements are derived on top of the metrics derived by the sensors which are usually sampled only after the sensor has been stabilized.

The object of the sets of electrical measurements is to derive a sensor-unique fingerprint that will enable to distinguish it from other sensors on the network and associate the metrics derived by the sensor with the sensor in a one-to-one relationship. Even more importantly, the fingerprinting of each sensor will enable the network to determine whether a replacement of a specific sensor has been taken place. This use case is crucial in cyber-related applications where network integrity is being monitored.

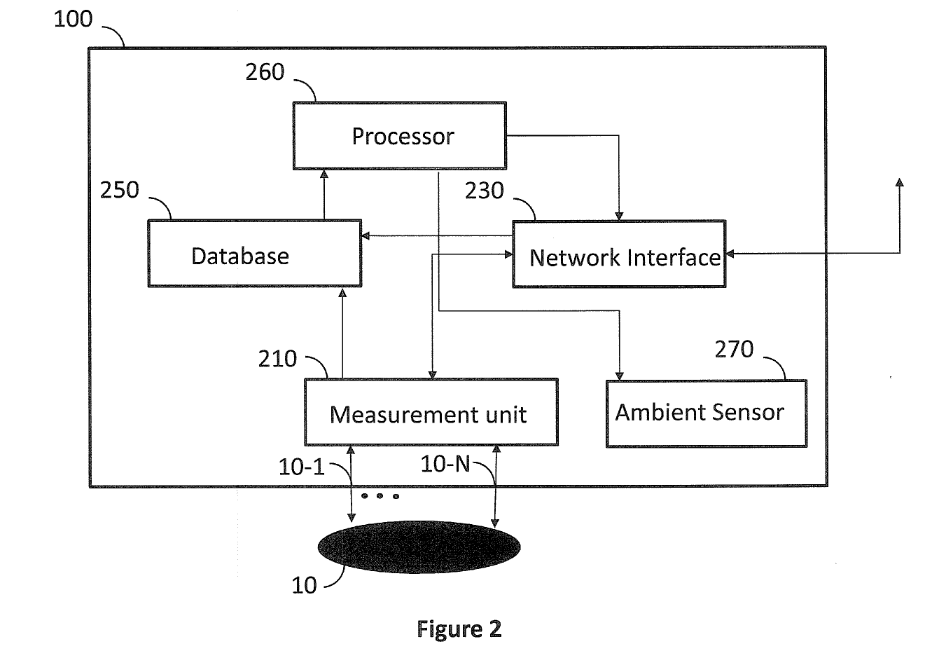

FIG. 2 is an exemplary non-limiting architecture of a device that serves as a local, on-site sensor controller in accordance with some embodiments of the present invention. Exemplary device 100 may include a measurement unit 210 configured to apply, at specified time slots, a set of electrical measurements to a sensor 10 over a plurality of wires 10-1 to 10-N to yield a set of electrical parameters. Device 100 may be connected to a network of sensors via network interface 230.

Device 100 further includes a processor 260 configured to: derive data measured by the sensor at said time slots; represent, for at least some of the time slots, the set of electrical parameters and the corresponding data measured by the sensor, as a vector in a single samples space on a database 250; and apply machine learning techniques to the vectors in the samples space, to derive a sensor-specific fingerprint of the sensor.

According to some embodiments of the present invention, device 100 may further include an ambient sensor 270 configured to derive, at specified time slots, ambient measurements being measurements indicative of an ambience of the sensor, wherein the processor is configured to carry out the representing and the applying take into account the ambient measurements.

According to some embodiments of the present invention, the ambient conditions include at least one of temperature, humidity, and pressure.

According to some embodiments of the present invention, the deriving of the ambient conditions may be carried out independently of the sensor.

According to some embodiments of the present invention, the set of electrical measurements comprises measuring a complex impedance of sensor 10.

According to some embodiments of the present invention, the set of electrical measurements includes injecting a predefined signal onto the sensor and measuring a response to the injected signal.

According to some embodiments of the present invention, the sensor complies with a specific communication protocol such as TCP-IP, Modbus, and Fieldbus.

According to some embodiments of the present invention, the electrical measurements may include injecting a signal or a series of signals that are non-compliant with said protocol and analyzing the response to the injected signals. The response may be indicative of a malicious intervention or a cyber-attack.

According to some embodiments of the present invention, the injected signals are on a communication level, and the response is indicative of a deviation from an expected response value in latency terms.

According to some embodiments of the present invention, the injected signals are on an application level, and the response is indicative of a deviation from an expected response value in validity terms.

According to some embodiments of the present invention, the machine learning techniques may include at least one of: clustering; nearest neighbor analysis; and neural networks.

According to some embodiments of the present invention, the derivation of the fingerprint is carried out locally, proximal to the sensor.

According to some embodiments of the present invention, network interface 230 is configured to convey the measurements over the network, and the derivation of the fingerprint or a part of the derivation is carried out remotely from the sensor.

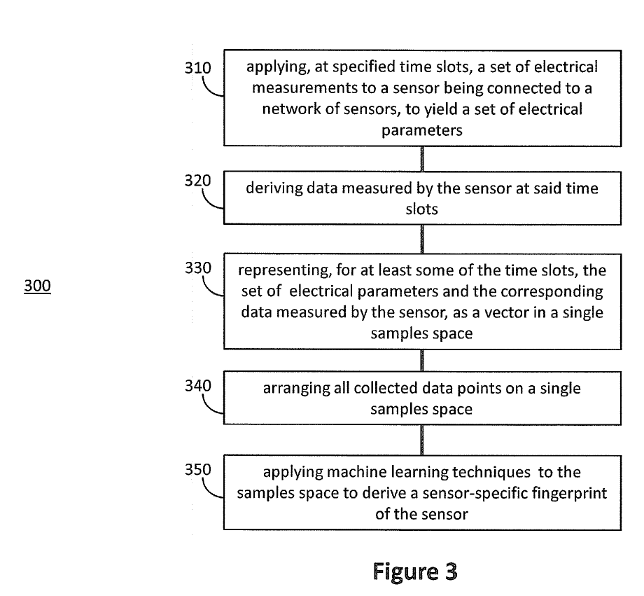

FIG. 3 is a flowchart according to some embodiments of the present invention. Method 300 is a method for determining a transmit schemes of a network-connected measurement unit based on wireless network time-varying characteristic. Method 300 may include the following steps: applying, at specified time slots, a set of electrical measurements to a sensor being connected to a network of sensors, to yield a set of electrical parameters 310; deriving data measured by the sensor at said time slots 320; representing, for at least some of the time slots, the set of electrical parameters and the corresponding data measured by the sensor, as a vector in a single samples space 330; arranging all collected data points on a single samples space 340; and applying machine learning techniques to the samples space to derive a sensor-specific fingerprint of the sensor 350.

As will be appreciated by one skilled in the art, aspects of the present invention may be embodied as a system, method or an apparatus. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit, “module” or “system.”

The aforementioned flowchart and block diagrams illustrate the architecture, functionality, and operation of possible implementations of systems and methods according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that, where the claims or specification refer to “a” or “an” element, such reference is not be construed that there is only one of that element.

It is to be understood that, where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method for identifying network-connected sensor, the method comprising:
applying, at specified time slots, a set of electrical measurements to a sensor being connected to a network of sensors, to yield a set of electrical parameters;
deriving data measured by the sensor at said time slots;
representing, for at least some of the time slots, the set of electrical parameters and the corresponding data measured by the sensor, as a vector in a single samples space; and
applying machine learning techniques to the vectors in the samples space, to derive a sensor-specific fingerprint of the sensor.

2. The method according to claim 1, further comprising deriving, for said time slots, ambient measurements being measurements indicative of an ambience of the sensor, wherein the representing and the applying take into account the ambient measurements.

3. The method according to claim 2, wherein the ambient conditions comprise at least one of: temperature, humidity, and pressure.

4. The method according to claim 2, wherein, the deriving of the ambient conditions is carried out independently of the sensor.

5. The method according to claim 1, wherein said set of electrical measurements comprises measuring a complex impedance of said sensor.

6. The method according to claim 1, wherein said set of electrical measurements comprises injecting a predefined signal onto the sensor and measuring a response to the injected signal.

7. The method according to claim 1, wherein in a case that the sensor complies with a communication protocol, the electrical measurements comprise injecting a signal or a series of signals that are non-compliant with said communication protocol and analyzing the response to the injected signals.

8. The method according to claim 7, wherein the injected signals are on a communication level, and wherein the response is indicative of a deviation from an expected response value latency terms.

9. The method according to claim 7, wherein the injected signals are on an application level, and wherein the response is indicative of a deviation from an expected response value in validity terms.

10. The method according to claim 1, wherein the machine learning techniques comprises at least one of: clustering; nearest neighbor analysis; and neural networks.

11. The method according to claim 1, wherein the derivation of the fingerprint is carried out locally, proximal to the sensor.

12. The method according to claim 1, wherein the derivation of the fingerprint or a part of the derivation is carried out remotely to the sensor.

13. A system for identifying network-connected sensor, the system comprising:
a measurement unit configured to apply, at specified time slots, a set of electrical measurements to a sensor being connected to a network of sensors, to yield a set of electrical parameters; and
a processor configured to;
derive data measured by the sensor at said time slots;
represent, for at least some of the time slots, the set of electrical parameters and the corresponding data measured by the sensor, as a vector in a single samples space on a database; and
apply machine learning techniques to the vectors in the samples space, to derive a sensor-specific fingerprint of the sensor.

14. The system according to claim 13, further comprising an ambient sensor configured to derive, for said time slots, ambient measurements being measurements indicative of an ambience of the sensor, wherein the processor id configured to carry out the representing and the applying take into account the ambient measurements.

15. The system according to claim 14, wherein the ambient conditions comprises at least one of: temperature, humidity, and pressure.

16. The system according to claim 14, wherein the deriving of the ambient conditions is carried out independently of the sensor.

17. The system according to claim 13, wherein said set of electrical measurements comprises measuring a complex impedance of said sensor.

18. The system according to claim 13, wherein said set of electrical measurements comprises injecting a predefined signal onto the sensor and measuring a response to the injected signal.

19. The system according to claim 13, wherein, in a case that the sensor complies with a communication protocol, the electrical measurements comprise injecting a signal or a series of signals that are non-compliant with said communication protocol and analyzing the response to the injected signals.

20. The system according to claim 19, wherein the injected signals are on a communication level, and wherein the response is indicative of a deviation from an expected response value in latency terms.

21. The system according to claim 19, wherein the injected signals are on an application level, and wherein the response is indicative of a deviation from an expected response value in validity terms.

22. The system according to claim 13, wherein the machine learning techniques comprises at least one of: clustering; nearest neighbor analysis; and neural networks.

23. The system according to claim 13, wherein the derivation of the fingerprint is carried out locally, proximal to the sensor.

24. The system according to claim 13, further comprising a network interface configured to convey the measurements over the network, wherein the derivation of the fingerprint or a part of the derivation is carried out remotely from the sensor.
